(19) United States
(12) Patent Application Publication
(10) Pub. No.: US 2004/0103044 A1
(43) Pub. Date: May 27, 2004

(54) System and method of protecting and promoting digital content

(76) Inventors: Eric J. Vandewater, Scottsdale, AZ (US); Peter Jacobs, Phoenix, AZ (US)

Correspondence Address: KNOBLE & YOSHIDA, LLC, Suite 1350, Eight Penn Center, 1628 John F. Kennedy Blvd., Philadelphia, PA, 19103, US

(21) Appl. No.: 10/412,453

(22) Filed: Apr. 11, 2003

Related U.S. Application Data
(63) Continuation-in-part of application No. 10/304,259, filed on Nov. 26, 2002.

(51) Int. Cl. G06F 17/60

(52) U.S. Cl. 705/27

(57) ABSTRACT

A system and method of marketing digital content such as audio and video works involves collecting recommendation information as to a specific digital work and a specific individual to which the digital work is being recommended. Preferably, this is accomplished by software that is provided in a second data session of a digital recordation of content, such as a CD or DVD, containing the digital work. The software gives the license holder the option to recommend one or more works on the digital recordation of content to a third party such as a friend. An Internet server receives the recommendation and contacts the third party using electronic mail, providing a unique link offering access to the recommended work on a limited basis for promotional purposes.

This is a continuation-in-part of application Ser. No. 10/304,259, filed Nov. 26, 2002, the entire disclosure of which is hereby incorporated by reference as if set forth fully herein.

### BACKGROUND OF THE INVENTION

1. Field of the Invention

This invention relates generally to the field of digital recordation and distribution of protected content of works such as audio compositions and video productions. More specifically, this invention relates to an improved system and method of protecting such digital content from unlawful copying and distribution by using a personal computer.

2. Description of the Related Technology

The widespread use of personal computers and Internet access has permitted extensive unauthorized digital extraction, reproduction and distribution of a significant amount of artistic content, including audio, video, software, images and text. Significant contributing factors to this unauthorized distribution include the large volume of digital content that has been made available to consumers in formats such as audio CD, CD-ROM, CD-R, DVD and DVD-R media and the ease of digital extraction and duplication of the music or other content on these physical media. Unfortunately, the standards used to produce the content for audio CDs (e.g., the IEC 60908 Redbook Standard) were not originally intended to prevent transfer of the content in digital or analog form and do not use methods to conceal the digital data on the CD for preventing unauthorized transfer. Further, copies made using digital processes are of high quality. Even copies using compressed formats such as, for example, the standard MPEG Audio Layer 3 (MP3) format or Microsoft's Windows® Media (WMA) format, are of good quality in comparison to prior analog copying approaches.

The music industry in particular has a strong interest in protecting its proprietary works from unauthorized copying and distribution, especially over the Internet or through other computer-based copying and distribution using music ripping software or other techniques. A number of attempts have been made by the music industry to provide music CDs that can be reliably played in consumer CD players but that somehow are resistant to digital audio extraction by a personal computer. Although there has been some success in this area, anything less than 100 percent playability by the wide array of consumer CD players that are already in use is extremely undesirable. When a consumer purchases a new CD he or she expects it to play in his or her equipment, and there is a great amount of anger and frustration if it does not. The record industry is extremely reluctant to take the risk of this happening to its ultimate consumers who appropriately purchase its music offerings. In addition, the reliability of protection against unauthorized copying and other digital extraction provided by the techniques that have been so far developed by the industry has been haphazard, being highly dependent upon specific hardware characteristics, firmware versions and countermeasures that have been employed by various forms of software. Another disadvantage of such technology is that it prevents a consumer who has legitimately purchased a compact disc from playing music files from the compact disc using his or her computer. Many consumers who purchase music on compact discs expect to be able to play them on their computers, or at least to extract the music to their hard drives using software that contains a digital rights management protocol, such as Windows Media Player®.

A need exists for an improved system and method for protecting digital content that does not adversely affect playability, that reliably prevents unauthorized duplication of digital content and that furthermore provides consumers in opportunity to play music that they have purchased on their personal computers. A need further exists for such a system, that permits friends and communities to share digital content over the Internet, but without the risk of uncontrolled unlicensed dissemination of the type that has been taking place in recent years.

### SUMMARY OF THE INVENTION

Accordingly, it is an object of the invention to provide an improved system and method for protecting digital content that does not adversely affect playability, that reliably prevents unauthorized duplication of digital content and that furthermore provides consumers in opportunity to play music that they have purchased on their personal computers.

It is further an object of the invention to provide such a system that will permit friends and communities to share digital content over the Internet, but without the risk of uncontrolled unlicensed dissemination of the type that has been taking place in recent years.

In order to achieve the above and other objects of the invention, a digital recordation of content according to a first aspect of the invention includes a first session containing a work, the first session being provided in a first digital format; a second session also containing the work, the second session being provided in a second digital format that is different than the first digital format; and a promotional system on the second session for directing a third party to an offer of limited access to the work.

According to a second aspect of the invention, a digital recordation of content may include a first session containing a work; and a second session that includes a promotional system for directing a third party to a source of limited access to the work.

According to a third aspect of the invention, a method of operating a personal computer is performed by positioning a digital recordation of content in a hardware device in the personal computer that is capable of reading the digital recordation of content; verifying that the digital recordation of content is properly licensed; and presenting an option to the user of the personal computer to have limited access to at least one work that is provided on the digital recordation of content promotionally offered to a third party.

According to a fourth aspect of the invention, a method of marketing digital content includes steps of collecting recommendation information as to a specific digital work and a specific individual to which the digital work is being recommended; and sending electronic mail to the specific individual offering limited access to the specific digital work.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a diagrammatical depiction of a digital recordation of content constructed according to a preferred embodiment of the invention;

FIG. 2 is a logical map of the digital recordation of content that is depicted in FIG. 1;

FIGS. 3A and 3B are a flow chart depicting a process of operating a personal computer according to a preferred embodiment of the invention;

FIG. 4 is an example of data that may be requested from the digital recordation of content by a top-level software program;

FIG. 5 is an example of incorrect data that may be provided to the top-level software program according to one aspect of the invention;

FIG. 6 is a flow chart depicting an alternative portion of the process depicted in FIGS. 3A and 3B;

FIG. 7 is a diagrammatical depiction of a system for promoting digital works according to an alternative embodiment of the invention;

FIG. 8 is a diagrammatical depiction showing several steps in a process that is performed according to the preferred embodiment of the invention; and

FIG. 9 is a diagrammatical depiction showing several additional steps in the process that is performed according to the preferred embodiment of the invention.

### DETAILED DESCRIPTION OF THE PREFERRED EMBODIMENT(S)

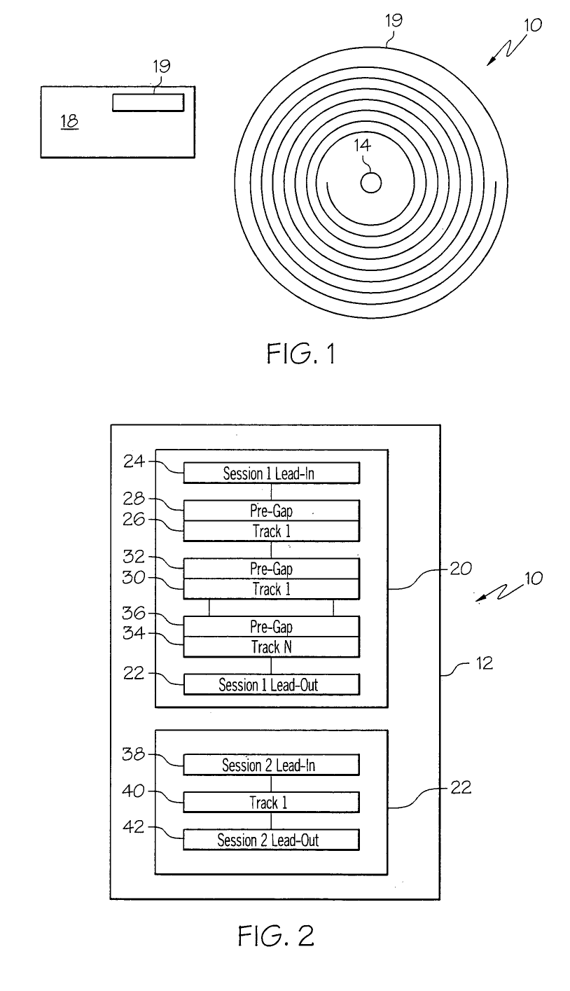

Referring now to the drawings, wherein like reference numerals designate corresponding structure throughout the views, and referring in particular to FIG. 1, a digital recordation of content 10 that is constructed according to a preferred embodiment of the invention is preferably embodied as a compact disc or CD 12 which, according to industry standard specifications, includes a center hole 14 and a continuous track 16 that is arranged in a helical pattern around the center hole 14. Information on a compact disc is recorded in a plurality of optically readable marks in a format that is specified by one or more industry standards. For example, data information is specified by what is commonly referred to as the Yellow Book standard, while audio information is provided a format that is specified by the Red Book standard. The information is typically pressed into the material from which the compact disc is made, forming embossed pits and lands between the pits, each of which represents a single unit of binary or digital information.

Although in the preferred embodiment of the invention the digital recordation of content 10 is embodied as a compact disc, it should be understood that a digital recordation of content could alternatively take the form of a digital versatile disc or DVD, optical or magnetic digital tape, a hard drive, or any of a plurality of possible types of portable digital media, such as memory sticks, high-capacity magnetic storage cartridges or wireless remote storage options.

Also shown schematically in FIG. 1 is a personal computer 18 that has installed therein a hardware device for reading the digital recreation of content 10. In the preferred embodiment, the hardware device is a CD-ROM drive 19 that is capable of reading information from the compact disc 12. Alternatively, the hardware device could be a DVD ROM drive, a magnetic or optical tape reader or any other type of hardware that is appropriate for reading the digital recordation of content 10 that may be selected within the broad scope of the invention.

Referring now to FIG. 2, which is a logical map of the compact disc 12 shown in FIG. 1, it will be seen that the compact disc 12 is formatted as a multi-session compact disc, having a first audio session 20 and a second data session 22. It will be seen that the first audio session 20 includes a lead in portion 24, which according to industry specifications includes a table of contents identifying the specific sectors on the compact disc 12 on which particular information within the first session 20 is contained. For example, the table of contents will include information as to the physical position on the compact disc 12 of a first audio track 26, and of subsequent audio tracks. The table of contents will also contain information that will alert the personal computer 18 of the presence of the second, data session 22.

As is further shown in FIG. 2, first session 20 further includes the first audio track 26 briefly discussed above. As is standard in the industry, first audio track 26 contains a pre-gap portion 28, which is typically a two second period of silence at the beginning of the audio track 26. Similarly, first audio session 20 includes a second audio track 30 also having a pre-gap area 32 and a plurality of additional audio tracks as may be required to record a desired audio work, terminating with a final audio track 34, also having a pre-gap area 36.

The second data session 22 also includes a lead in area 38 containing a table of contents and at least one data track 40, the contents of which will be describing greater detail below. The second data session 22 terminates with a lead out area 42.

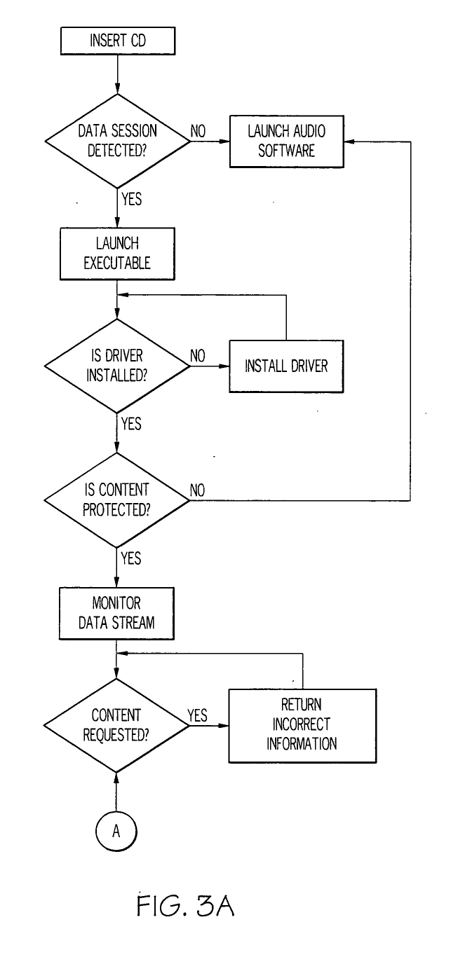

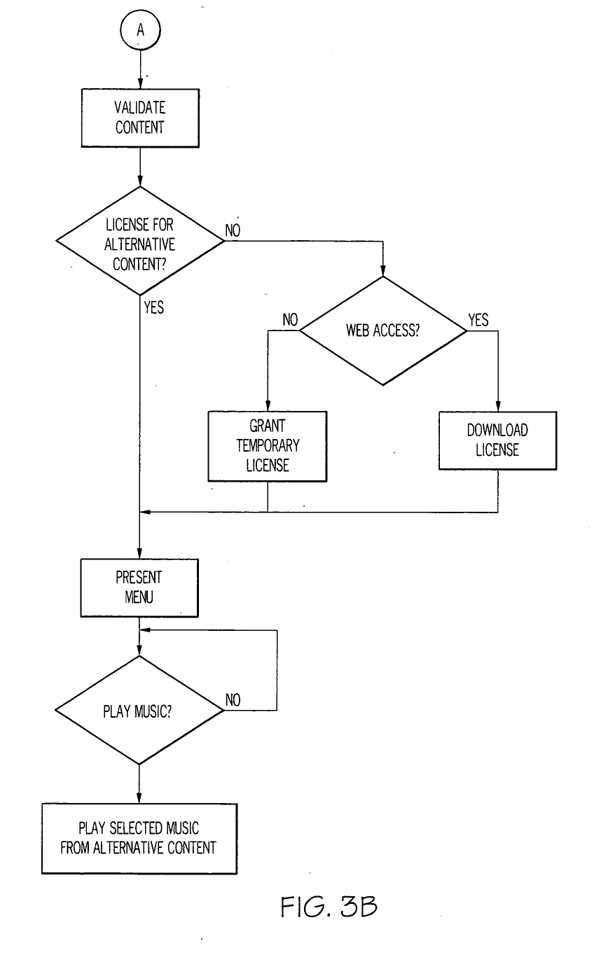

Preferably, the data track 40 includes a plurality of data files, including a file that instructs the personal computer 18 to automatically execute an executable or program file. In a Windows operating environment, the file that instructs the personal computer to automatically execute the program file is typically an .inf file format. Referring now to FIG. 3A, it will be seen that when a compact disc 12 is inserted into the CD ROM drive 19 of the personal computer 18 the operating system will detect whether or not a data session is present. If a data session is not detected, such as when a regular audio compact disc is inserted into the CD ROM drive 19, the operating system of the personal computer 18 will automatically launch software, such as Windows Media Player®, to play the files in the audio session as is conventional given the current state of the industry.

If, however, a data session is detected, and the data session is the second session 22 described above with reference to FIG. 2, the operating system will be instructed to launch an executable program file. The executable program will first inquire as to whether a specialized driver according to one important aspect of the invention has been installed in the personal computer 18. If the executable program determines that the driver has in fact not been installed, it will, preferably automatically, install the driver itself. Optionally, the executable program may inquire of the operator as to whether permission is given for installation of software, which would include the specialized driver.

After installation of the driver, the driver will periodically poll the CD ROM drive 19 and any additional CD ROM or DVD ROM drives as to whether a digital recordation of content 10 is present containing content that is protected according to the invention. This may be done on a session by session basis or on an audio track by audio track basis, according to possible alternative embodiments of the invention. Preferably, the digital recordation of content 10 is encoded to indicate whether or not content recorded thereon is protected. In one embodiment of the invention that is depicted in FIG. 6, a specific digital code is provided in the pre-gap area of each audio track to indicate whether or not the audio content contained on that audio track is protected. By encoding the pre-gap area, the integrity of the work that is recorded on the audio track is not in any way affected by the presence of this additional data. Alternatively, the presence of protected content on the compact disc 12 could be indicated to the personal computer 18 and specifically the specialized driver by any one of a number of different techniques, such as by searching for a particular file in the second data session, reviewing the size of a particular file, performing a check sum on a particular file or numbers of files, or looking for data within one or more particular files or within a predetermined sector or sectors. Specifically, a digital code could be added to the table of contents, to one of the P-W subchannels, to a reserved area on the yellow book session, or in the lead-out. Alternatively, the digital code could be added to the red book session, or in the audio data itself.

If the specialized driver determines that there is no protected content, the default audio software may be launched by the operating system of the personal computer 18, and the content contained within the audio tracks of the compact disc may be played normally without interference from the specialized driver. In the embodiment of the invention that shown in FIG. 6, where each audio track is checked for protected content, the default audio software may be permitted to access data from nonprotected tracks without interference from the specialized driver while data from protected tracks will be prevented from reaching the default audio software intact, as will be described in greater detail below.

Once protected content is detected on the digital recordation of content 10 the specialized driver, the specialized driver will monitor the data stream between the hardware device in which the digital recordation of content 10 is installed, which in the preferred embodiment is the CD ROM drive 19, and any software application running on the personal computer 18 that may request information from the protected content. In the preferred embodiment, the specialized driver monitors the low-level SCSI command set instructions that are given to the CD ROM drive 19. When a software application such as those that are typically used to “rip” or create compressed digital audio files such as MP3s attempt to access the digital information that is contained on a protected audio track, the specialized driver will detect this request on the SCSI command level and, instead of returning the requested information will return incorrect information to the software application. This incorrect information may be accurate information from a sector other than the sector from which the information was requested, completely random information, or the requested information upon which additional information has been superimposed. For example, the requested information could be returned with additional superimposed encoding that will have the effect of providing periodic unpleasant noises such as beeps or a prerecorded voice indicating that protected content is being requested. Preferably, the information that is returned by the specialized driver to the software application is returned in such a way that the software application will not be able to detect that anything other than the requested information has been provided. As a result, it will be difficult to employ effective countermeasures within the software application.

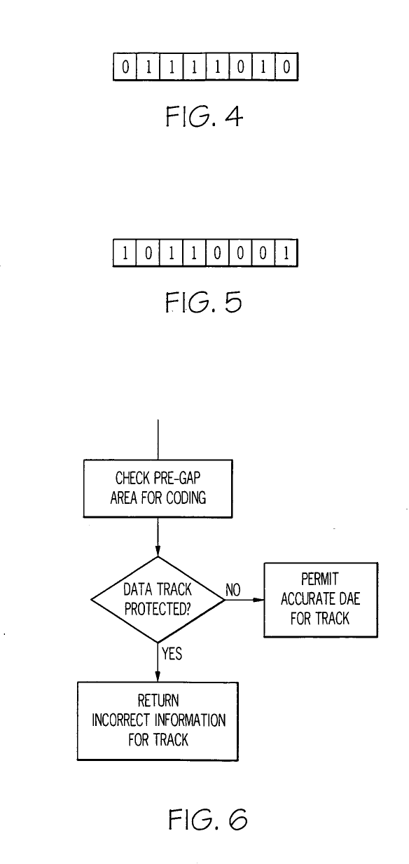

Referring briefly to FIGS. 4 and 5, FIG. 4 represents a sampling of the actual data that may be requested from a protected audio track by a software application such as an MP3 ripping software or CD burning software. FIG. 5 represents the actual data that may be returned to the software application by the specialized driver.

According to one important aspect of the invention, the second data session 22 includes within the single data track 40 the entire work that is provided within the first audio session 20, but in a second, alternative digital format that is different from the digital format that is used in the first audio session 20. In the preferred embodiment, the digital information that is included in the first audio session 20 is in the standard WAV format that is used in industry standard compact audio discs. The alternative digital format of the work in the second data session 22 is preferably provided in a Windows Media WMA format, which is subject to a digital rights management (DRM) protocol.

Referring now to FIG. 3B, at some point after determining that the digital recordation of content 10 contains protected content the executable program will first perform a check to determine whether the digital recordation of content is an original recordation, or an unauthorized copy. If it is determined to be an unauthorized copy, an error message will be produced and the program will refuse to deliver the license and to continue to run.

The executable program will then perform a check to determine whether or not a license is present for the alternative content that is provided in the second data session 22. If no license is present, and the personal computer 18 has an active Internet connection, the executable program will attempt to download a license from a predetermined Internet server. If no Internet connection is available, a temporary license will be granted giving the operator of the personal computer 18 the ability to play the alternative content provided in the second data session 22 a limited number of times.

After ensuring that a license is present the executable program will present a menu to the operator of the personal computer 18, which may be performed by launching the Web browser and providing a user interface in HTML format. The menu will enable the operator to play desired content from the alternative digital format. The operator will also be able to attempt to play the audio content that is contained in the first session, however the content will not have the desired sound quality because of the incorrect data that is being returned by the specialized driver to the software program that is attempting to play the desired audio track.

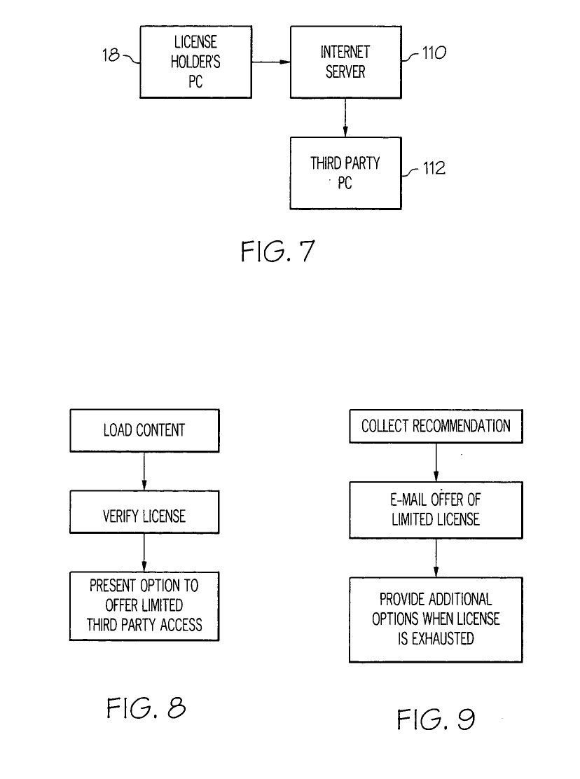

Additionally, as is shown diagrammatically in FIG. 8, the menu may offer the operator of the personal computer 18 the option to recommend one or more digital works that are contained on the digital recordation of content to a third party such as a personal friend on a limited basis for promotional purposes. Typically, this will appear as an option on the menu that, which when selected, will give the operator of the personal computer 18 a list of the various works, such as audio tracks, that may be recommended. At the option of the content provider, this may be all of the works on the digital recordation of content, just one work, or several selected works. Preferably, a hyperlink is provided for each work that may be recommended, and when that hyperlink is selected, a screen is brought up that gives the operator of the personal computer 18 the option of entering an electronic mail address of the third party to which the work is being recommended. As is detected in FIG. 7, the license holder's personal computer 18 communicates with an Internet server 110 via the Internet, communicating information to the Internet server 110 that includes the identity of the work being recommended and the electronic mail address of the third party. Optionally, additional information could be transmitted to the Internet server 110, such as identification information that may be encoded on the digital recordation of content, the IP address of personal computer 18 or an identity or identity code of the person operating the personal computer 18 or of the personal computer 18 itself. For example, information may be encoded on the digital recordation of content that is representative of the identity of the retailer of from which the digital recordation of content was purchased. In this case, the Internet server 110 when referring the third party to a retailer for the purpose of purchasing a permanent licensed copy of the digital recordation of content as will be describing greater detail below will have the ability to direct the third party to the retailer that sold the original digital recordation of content.

Upon receiving the recommendation, Internet server 110 will send an electronic mail message to the third party, which will be received at a third party personal computer 112. Internet server 110 will provide in the electronic mail message a unique hyperlink that will enable the third party personal computer 112 to access the recommended digital works on a limited basis only. The electronic mail message may either direct the third party operating the personal computer 112 to an Internet web page containing the unique hyperlink, or provide the hyperlink directly in the electronic mail message. In the embodiment in which a web page is displayed, additional options may be made available to the third party using the web page and/or additional advertising for promotional offers may be displayed using the web page. In one embodiment, the limited access provided by the unique hyperlink will be limited to a number of times that the work may be played or displayed on the personal computer 112. In another embodiment, this limited access will be defined by a limited period of time, such as one week, that the personal computer 112 will be permitted to play or display of the recommended works.

The hyperlink that is provided to the third party by the Internet server 110 is unique in the sense that it may only be used once. If the operator of the third party personal computer 112 attempts to cut and paste the hyperlink and transmit it to another personal computer, the other personal computer will be unable to effectively use it. Likewise, if the operator of the personal computer 112 attempts to reuse the hyperlink after the original limited license is exhausted, the link may not be used to obtain any additional license.

In the preferred embodiment, the unique hyperlink that is provided by the Internet server 110 will permit the download to personal computer 112 of a digital media file that is subject to a digital rights management protocol, such as Microsoft DRM. For example, an audio file may be downloaded as a Windows Media (WMD) file. When the third party attempts to play or display the downloaded file on the personal computer 112, the digital rights management protocol will communicate with the Internet server 110 to verify that the limited promotional license is still active.

As is shown diagrammatically in FIG. 9, if the limited license is exhausted, the third party operating the personal computer 112 will be directed to an Internet web site where purchase of permanent access to the recommended works will be offered to the third party. In one embodiment, this may be accomplished by offering the purchase of a permanent electronic license that will permit the continued play or display of the downloaded file on the personal computer 112. In another embodiment, the purchase of a physical digital recordation of content such as a CD or DVD may be offered. This offer may be made directly by the Internet server 110 or by referring the third party to an Internet retailer. Optionally, all of these options may be offered to the third party.

According to one important aspect of the invention, information that is received by the Internet server 110 may be analyzed for the purpose of determining consumer preferences and for targeted advertising. For example, information may be collected as to the number of recommendations that are made for each specific digital work, the number of downloads that are consummated in comparison to the number of recommendations that are made for a particular work, and the number and percentage of times return for the purchase of licenses or other products, indicating interest in the recommended works. Internet server 110 may operate as a referring portal to one or more electronic retailers, collecting a business commission for each sale that is consummated.

Although the invention as it has been described with reference to its preferred embodiment is specific to audio files that are contained on compact discs, it should be understood that the invention is equally applicable to other file formats, such as digital video file formats. For example, a DVD containing content such as a movie could be protected against accurate digital extraction by a personal computer by implanting a driver as described above with reference to the preferred embodiment, and an alternative source of the content could be provided an alternative digital file format on a second, data session of the DVD.

In an alternative embodiment of the invention, instead of monitoring the data flow and interfering the drive could be periodically queried to determine what it is doing and what part of the CD it is currently accessing. A command to eject or stop the CD may then be sent to the drive to cancel the data retrieval process.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A digital recordation of content, comprising:
a first session containing a work, said first session being provided in a first digital format;
a second session also containing said work, said second session being provided in a second digital format that is different than said first digital format; and
promotional means on said second session for directing a third party to an offer of limited access to said work.

2. A digital recordation of content according to claim 1, wherein said work is an audio work, and wherein said first digital format is a digital format that is recognizable by consumer audio players.

3. A digital recordation of content according to claim 2, wherein said recordation on said first session comprises a digitally unaltered reproduction of said work.

4. A digital recordation of content according to claim 2, wherein said second session is coded to be recognized by a computer as a data session.

5. A digital recordation of content according to claim 2, wherein said second session comprises means for installing software into a personal computer.

6. A digital recordation of content according to claim 2, wherein said second session is constructed and arranged to present a menu to a user of a personal computer, and wherein said menu provides an option to initiate said promotional means.

7. A digital recordation of content according to claim 1, wherein said promotional means comprises means for directing a third party by electronic mail to a source of limited access to said work.

8. A digital recordation of content according to claim 1, wherein said promotional means comprises means for obtaining an electronic mail address of said third party.

9. A digital recordation of content according to claim 8, wherein said promotional means further comprises means for forwarding said electronic mail address to an Internet server.

10. A digital recordation of content according to claim 9, wherein said work contains a plurality of different selections, and wherein said promotional means is constructed and arranged to direct said third party to a number of said selections that is less than a total number of said selections in said work.

11. A digital recordation of content according to claim 10, wherein said promotional means is further constructed and arranged to forward to said Internet server the identity of at least one selection to which limited access will be offered.

12. A digital recordation of content, comprising:
a first session containing a work; and
a second session, said second session including promotional means for directing a third party to a source of limited access to said work.

13. A digital recordation of content according to claim 12, wherein said second session comprises means for installing software into a personal computer.

14. A digital recordation of content according to claim 12, wherein said second session is constructed and arranged to present a menu to a user of a personal computer, and wherein said menu provides an option to initiate said promotional means.

15. A digital recordation of content according to claim 12, wherein said promotional means comprises means for directing a third party by electronic mail to a source of limited access to said work.

16. A digital recordation of content according to claim 12, wherein said promotional means comprises means for obtaining an electronic mail address of said third party.

17. A digital recordation of content according to claim 16, wherein said promotional means further comprises means for forwarding said electronic mail address to an Internet server.

18. A digital recordation of content according to claim 17, wherein said work contains a plurality of different selections, and wherein said promotional means is constructed and arranged to direct said third party to a number of said selections that is less than a total number of said selections in said work.

19. A digital recordation of content according to claim 18, wherein said promotional means is further constructed and arranged to forward to said Internet server the identity of at least one selection to which limited access will be offered.

20. A method of operating a personal computer, comprising:
(a) positioning a digital recordation of content in a hardware device in the personal computer that is capable of reading said digital recordation of content;
(b) verifying that said digital recordation of content is properly licensed; and
(c) presenting an option to the user of the personal computer to have limited access to at least one work that is provided on said digital recordation of content promotionally offered to a third party.

21. A method of operating a personal computer according to claim 20, wherein step (c) is performed by permitting the user to enter an electronic mail address of the third party.

22. A method of operating a personal computer according to claim 21, further comprising a step of providing said electronic mail address to an Internet server.

23. A method of operating a personal computer according to claim 22, further comprising a step of providing said Internet server with the identity of at least one selected work on said digital recordation of content to which limited access will be provided to said third party.

24. A method of marketing digital content, comprising:
(a) collecting recommendation information as to a specific digital work and a specific individual to which the digital work is being recommended; and
(b) sending electronic mail to the specific individual offering limited access to said specific digital work.

25. A method of marketing digital content according to claim 24, wherein said specific digital work is an audio work.

26. A method of marketing digital content according to claim 24, wherein step (a) is performed by receiving the electronic mail address of the specific individual from an existing licensee of the digital content.

27. A method of marketing digital content according to claim 24, wherein step (b) is performed by sending electronic mail to the specific individual containing a hyperlink that will provide limited access to the specific digital work.

28. A method of marketing digital content according to claim 27, wherein said hyperlink is constructed and arranged so that it may be used only one time.

29. A method of marketing digital content according to claim 27, wherein said hyperlink provides access to digital content containing said work, and wherein access to said digital content is controlled by a digital rights management protocol.

30. A method of marketing digital content according to claim 24, wherein said limited access to said specific digital work is limited by the number of times the digital work may be played by the specific individual.

31. A method of marketing digital content according to claim 30, wherein said limited access to said specific digital work is limited by the amount of time the digital work may be played by the specific individual.

32. A method of marketing digital content according to claim 24, further comprising providing additional options to the specific individual when the limited access to the specific digital work has been exhausted.

33. A method of marketing digital content according to claim 32, wherein said additional options comprise providing the specific individual with an opportunity to purchase further access to said specific digital work.

34. A method of marketing digital content according to claim 32, wherein said additional options comprise referring the specific individual to a predetermined Internet web site.

35. A method of marketing digital content according to claim 24, wherein step (a) is performed by presenting a user at a personal computer with an option to recommend a specific digital work to the specific individual after a digital recordation of content that contains the specific digital work is inserted within the personal computer.

36. A method of marketing digital content according to claim 35, wherein said digital recordation of content includes at least one data session, and wherein said data session is constructed and arranged to present the user of the personal computer with an option to recommend a specific digital work to the specific individual.

37. A method of marketing digital content according to claim 24, further comprising analyzing said recommendation information for the purpose of determining consumer preferences.
